(19) United States
(12) Patent Application Publication
(10) Pub. No.: US 2007/0026116 A1
(43) Pub. Date: Feb. 1, 2007

(54) Method of producing food products in sheet form

(76) Inventor: Mylene Castro, Montmorency (FR)

Correspondence Address: YOUNG & THOMPSON, 745 SOUTH 23RD STREET, 2ND FLOOR, ARLINGTON, VA, 22202, US

(21) Appl. No.: 10/556,036

(22) PCT Filed: May 7, 2004
(86) PCT No.: PCT/FR04/01115

§ 371 Date: Feb. 24, 2006

(30) Foreign Application Priority Data
May 9, 2003 (FR) 03/05654

(51) Int. Cl. A21D 6/00

(52) U.S. Cl. 426/502

(57) ABSTRACT

A method of producing food products in the form of sheets includes preparing the pastry and, optionally, leaving the pastry to stand; distributing the pastry to cooking stations, depositing the pastry such as to form sheets and cooking same on one face thereof; recovering the sheets; and stacking the sheets before cooling and packing same. A treatment step, is performed when the sheets are removed from the cooking station but before stacking, consisting in treating at least one of the faces of the sheet in order to form a barrier thereon. The barrier prevents the moisture from migrating out of the sheet and rebalances moisture between the two faces. In this way, the stickiness of the sheet is reduced and the sheets can be stacked on top of one another without a separator. The invention can be used to produce sheet-type food products.

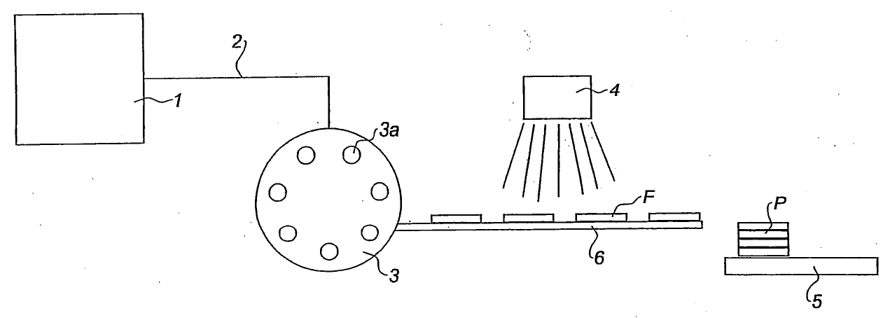

The present invention relates to a process for the production of food products in the form of sheets, such as sheets of brick, flat cakes, crepes and the like.

Food products in the form of sheets such as sheets of brick are produced in a semi-industrial way, the dough being distributed on one or several griddles, and then the sheet of dough thus baked is removed for its packaging in bags.

The sheets thus baked on the griddles are generally baked only on one surface which thus has a smooth, dry appearance whilst the other surface is soft, wet and clinging. Because of this, a simple stacking of said sheets leads to sticking of the sheets to each other. This renders difficult or even substantially impossible the ultimate use of these sheets.

So as to avoid these drawbacks, conventional processes for packaging sheets of brick use a sulfurized spacer for each sheet of brick. This spacer thus permits obtaining packaging of the sheets which avoids their sticking and which also improves the preservation of the sheets.

However, the emplacement of such for each sheet of a stack of 10 sheets has the most drawbacks both from the technical point of view and from an economic point of view.

Thus, the emplacement of the spacer cannot be automatically done and requires a manual station at the outlet of the cooking station, which limits the speed of production.

Moreover, the spacer represents the cost equivalent to that of the ingredients entering into the formulation of the product and the presence of said spacers, which are somewhat adherent to the product, complicates the use of the latter by the consumer or the restauranteur and in industry.

Finally, in the case of sheets of brick, it is necessary after stacking said sheets to cool them progressively in two stages. First a conditioning phase of about 12 hours at ambient temperature, this conditioning phase permitting equalizing the moisture between the two surfaces of the sheets so as to obtain a homogeneous product. Then a step of cooling in a cold chamber permits stabilizing the quality of the product in particular as to bacteriology and functionality.

Consequently, the present invention proposes to overcome these drawbacks by providing packaging food products in the form of sheets such as sheets of brick, in a stack without spacers and in an automatic manner, which will be more economical whilst offering a high quality product.

To this end, the invention has for its object a process for the production of food products in the form of sheets such as sheets of brick, flat cakes, crepes and the like, comprising the steps: of preparation of the dough, if desired aging said dough, distribution of the dough at cooking stations in which the dough is deposited in the form of sheets and baked on only one surface, in collecting the sheets and stacking said sheets before cooling and packaging, characterized in that it comprises moreover at the outlet of the cooking station and before stacking, a step of treatment of at least one of the surfaces of the sheet to form, on this surface or these surfaces, a barrier promoting the migration of moisture outwardly of the sheet and facilitating the balancing of the moisture between the two surfaces, and decreasing the sticking character of the sheet, the stacking of the sheets being thus achievable without a spacer.

Thus, the barrier formed on one of the two surfaces of the sheet decreases sufficiently or even eliminates the sticking characteristic of the sheet to permit stacking of the sheets directly one on the other without a spacer and without the risk of sticking.

According to a first embodiment of the invention, the step of treatment of at least one of the surfaces of the sheet consists in drying. This drying can preferably be carried out in an oven and/or by cooling. Thus, the sheets collected at the outlet of the cooking station can for example be deposited on a conveyor belt which brings them to the stacking station, the conveyor belt then passing through a drying tunnel. The drying and/or cooling temperatures are selected suitably to form on the one hand to barrier to humidity on at least one of the surfaces, but on the other hand to preserve the qualities of the sheet such as its flexibility, its soft character, its taste, for example by equalizing the moisture between the two surfaces of the sheet.

Thus, an installation for the production of food products in the form of sheets such as sheets of brick, flat cakes, crepes and the like, can comprise a preparation station and if desired aging station, for the dough, one of several cooking stations, in the form of sheets and on one surface only, dough brought from the preparation station to said cooking station by distribution means, means for collecting the sheets and a stacking position for said sheets, and which moreover comprises, between the cooking station and the stacking station, a drying tunnel traversed by the sheets.

Any other means of drying of at least one of the surfaces of the sheet are also suitable.

According to a second embodiment of the process according to the invention, the step of treatment of at least one of the surfaces of the sheet consists in depositing on the latter a pulverulent food ingredient forming on the surface or surfaces a film preventing the migration of the moisture toward the exterior of the sheet whilst facilitating the equalization of the moisture between the two surfaces and reducing the sticky character of said surface or surfaces.

This food ingredient can be selected from vegetable fibers such as lemon fibers, wheat fibers, inner fibers of peas, oat fibers and the like.

There can also be selected as the food ingredient amylase products such as potato flour, wheat starch, and the like.

This food ingredient can be selected from the family of diholosides such as maltose, cellobiose, trehalose.

Preferably, the pulverulent ingredient is deposited on the cooked surface of a sheet of brick.

Surprisingly, it has been discovered that the sheets of brick treated according to the process of the invention no longer needed an aging process of a dozen hours which was normally indispensable and that it is moreover possible immediately to package the stacked sheets, these cooling in their packaging.

The process according to the invention thus permits in advantageous manner a reduction of the time of production and hence greater productivity.

According to a third embodiment of the invention, the step of treating at least one of the surfaces of the sheet consists in depositing on this latter fine droplets of a food ingredient by spraying said ingredient forming on the surface or surfaces a film preventing the migration of moisture outwardly of the sheet and reducing the stickiness of the treated surface. Such a food ingredient can be constituted by fatty materials such as vegetable oil, cocoa butter.

The invention also has for its object a food product in a sheet such as a sheet of brick, a flat sheet, a crepe, etc., which comprises on at least one of its surfaces a film constituted by a pulverulent or fatty food ingredient.

The invention also provides an installation for the production of food products in the form of sheets such as sheets of brick, flat cakes, crepes and the like, comprising a preparation station and if desired aging station for the dough, one or several cooking stations, in the form of sheets and on a single face, of the dough brought from the preparation station toward said cooking station by distribution means, means for collecting the sheets and a stacking station for said sheets, characterized in that it comprises moreover, between the cooking station and the stacking station, a station for sprinkling or dusting at least one of the surfaces of the sheets.

Thus in an advantageous manner, the process of the invention can be practiced on installations already existing, because it suffices to modify the outlet of the cooking station by providing a powdering station. Moreover, the omission of the spacers permits envisaging an automation of the stacking station for the sheets.

The invention will now be described in greater detail with reference to the drawing, in which the single figure shows in a schematic manner the different stations of the installation for practicing the process according to the second embodiment of the invention.

The installation for preparing sheets of brick shown schematically in the single figure, comprises a preparation and if desired for aging the dough 1, distribution means 2 for the dough toward a cooking station 3, a powdering station 4 and a stacking station 5.

At the station 1 for preparing the dough, there is mixed in a vat the different ingredients (flour, water, technological ingredients) necessary for the production of the dough for sheets of brick, then if desired the dough is left to mature for 0 to 120 minutes.

The cooking station 3 being constituted by a rotating griddle having an inclined plane, and provided with a dozen plates 3a, the dough should be prepared so as to have a consistency adapted to cooking on an inclined plate. Thus, the prepared dough should be sufficiently fluid to spread suitably over the cooking plate but sufficiently thick to stay there without flowing, given that the plate is oblique and turned downwardly.

Distribution means 2 bring the dough to the different cooking stations, a single station being shown in the figure for purposes of clarity.

The dough is deposited on each cooking plate 3a whose temperature is adjusted between 110 and 200° C. The cooking time corresponds to the time of rotation of the griddle and at the end of cooking the sheet of brick F is removed from its support and falls on a conveyor belt 6 such as a mesh belt, its uncooked face against the belt, to be transported toward the stacking station 5.

The powdering station 4 is positioned above said belt 6 and preferably releases the pulverulent ingredient over the cooked surface of each sheet of brick F carried by said belt 6.

Once the sheet of brick F is covered with the pulverulent ingredient, it arrives at the second stacking station where the piles P of sheets of brick are formed. Each pile P comprises generally 10 sheets of brick. Each pile P is thus driven toward the packaging station where it is subjected to packaging.

1. Process for the production of food products in the form of sheets such as sheets of brick, flat cakes, crepes and the like, comprising the steps of:
preparation of the dough,
if desired maturing said dough,
distribution of the dough to cooking stations where the dough is deposited to form sheets and cooked on a single surface,
collection of the sheets and stacking said sheets before cooling and packaging,
characterized in that it comprises moreover, at the outlet of the cooking station and before stacking, a step of treatment of at least one of the surfaces of the sheet to form on this surface or these surfaces, a barrier preventing the migration of moisture outwardly of the sheet and facilitating the balancing of the moisture between the two surfaces, thereby decreasing the stickiness of the sheet, the stacking of the sheets being thus achievable without spacers.

2. Process according to claim 1,
characterized in that the step of treating of at least one of the surfaces of the sheet consists in drying.

3. Process according to claim 2,
characterized in that the drying is carried out by stoving and/or by cooling.

4. Process according to claim 1,
characterized in that the step of treatment of at least one of the surfaces of the sheet consists in applying thereto a pulverulent food product forming on the surface or surfaces a film preventing the migration of the moisture outwardly of the sheet and facilitating the equalization of the moisture between the two surfaces, and reducing the stickiness of said surface or surfaces.

5. Process according to claim 4,
characterized in that the applied food product is selected from vegetable fibers such as lemon fibers, wheat fibers, internal fibers of peas, oat fibers.

6. Process according to claim 4,
characterized in that the applied food product is selected from amylase products such as potato flour, wheat starch.

7. Process according to claim 4,
characterized in that the applied food product is selected from the family of diholosides such as maltose, cellobiose, trehalose.

8. Process according to claim 1,
characterized in that the added pulverulent food product is sprinkled or dusted on top of the sheets.

9. Process according to claim 1,
characterized in that the step of treatment of at least one of the surfaces of the sheet consists in depositing on the latter fine droplets of a food ingredient by spraying said ingredient forming on said surface of film preventing the migration of moisture outwardly of the sheet and reducing the stickiness of said surface, such as food ingredient being constituted preferably by fatty materials such as vegetable oils, cocoa butter.

10. Food product in the form of a sheet obtained by the process according to claim 1,
characterized in that it comprises on at least one of its surfaces a film constituted by a pulverulent food product.

11. Food product in the form of a sheet obtained by the process according to claim 1,
characterized in that it comprises on at least one of its surfaces a film constituted by a fatty food product.

12. Installation for the production of food products in the form of sheets such as sheets of brick, flat cakes, crepes and the like, comprising a preparation station and if desired aging station, for the dough (1), one or several stations (3) for cooking in the form of sheets and on a single surface, the dough brought from the preparation station (1) toward said cooking stations (3) by distribution means (2), means for collecting the sheets (F) and a stacking station (5) for said sheets (F),
characterized in that it comprises moreover between the cooking station (3) and the stacking station (5), a station (5) for sprinkling or powdering at least one of the surfaces of the sheets (F).

13. Installation for the production of food products in the form of sheets such as sheets of brick, flat cakes, crepes and the like, comprising a preparation station and if desired aging station for the dough (1), one or several stations (3) for cooking in the form of sheets and on a single surface, the dough brought from the preparation station (1) toward said cooking stations (3) by distribution means (2), means for collecting the sheets and a stacking station (5) for said sheets,
characterized in that it comprises moreover between the cooking station (3) and the stacking station (5), a tunnel for drying traversed by the sheets (F).

14. Process according claim 5,
characterized in that the added pulverulent food product is sprinkled or dusted on top of the sheets.

15. Process according claim 6,
characterized in that the added pulverulent food product is sprinkled or dusted on top of the sheets.

16. Process according claim 7,
characterized in that the added pulverulent food product is sprinkled or dusted on top of the sheets.

17. Process for the production of food products in the form of sheets such as sheets of brick, flat cakes, crepes and the like, comprising the steps of:
preparation of the dough,
if desired maturing said dough,
distribution of the dough to cooking stations where the dough is deposited to form sheets and cooked on a single surface,
collection of the sheets and stacking said sheets before cooling and packaging,
characterized in that it comprises moreover, at the outlet of the cooking station and before stacking, a step of treatment of at least one of the surfaces of the sheet to form on this surface or these surfaces, a barrier preventing the migration of moisture outwardly of the sheet and facilitating the balancing of the moisture between the two surfaces, thereby decreasing the stickiness of the sheet, the stacking of the sheets being thus achievable without spacers, process according to claim 4,
characterized in that the applied food product is selected from vegetable fibers such as lemon fibers, wheat fibers, internal fibers of peas, oat fibers.

18. Process for the production of food products in the form of sheets such as sheets of brick, flat cakes, crepes and the like, comprising the steps of:
preparation of the dough,
if desired maturing said dough,
distribution of the dough to cooking stations where the dough is deposited to form sheets and cooked on a single surface,
collection of the sheets and stacking said sheets before cooling and packaging,
characterized in that it comprises moreover, at the outlet of the cooking station and before stacking, a step of treatment of at least one of the surfaces of the sheet to form on this surface or these surfaces, a barrier preventing the migration of moisture outwardly of the sheet and facilitating the balancing of the moisture between the two surfaces, thereby decreasing the stickiness of the sheet, the stacking of the sheets being thus achievable without spacers, process according to claim 4,
characterized in that the applied food product is selected from the family of diholosides such as maltose, cellobiose, trehalose.
